(19) United States
(12) Patent Application Publication
(10) Pub. No.: US 2026/0366687 A1
(43) Pub. Date: Nov. 19, 2026

(54) VEHICLE LAMP

(71) Applicant: ICHIKOH INDUSTRIES, LTD., Isehara-shi (JP)

(72) Inventor: Kei ONOMA, Isehara-shi (JP)

(73) Assignee: ICHIKOH INDUSTRIES, LTD., Isehara-shi (JP)

(21) Appl. No.: 19/150,217

(22) PCT Filed: Jan. 30, 2024
(86) PCT No.: PCT/JP2024/002770

§ 371 Date: Jul. 23, 2025

(30) Foreign Application Priority Data
Jan. 31, 2023 (JP) 2023-013409

(51) Int. Cl. F21S 41/33; F21S 41/148; F21S 41/26; F21S 41/32

(52) U.S. Cl. CPC F21S 41/335; F21S 41/148; F21S 41/26; F21S 41/321

(57) ABSTRACT

A vehicle lamp includes: a light source; a reflector having a reflective surface that reflects light from the light source; and a projection lens that forms a light distribution pattern by irradiating the reflected light from the reflective surface in front of the vehicle. The main reflection area of the reflective surface has a first focal point located at or in the vicinity of the light source, and a second focal point located on the projection lens side of the first focal point. The projection lens has a rear focal point located on the light source side of the second focal point. The expansion area of the reflective surface reflects light from the light source toward the projection lens through a location on the light source side of the second focal point.

### TECHNICAL FIELD

The present disclosure relates to a vehicle lamp, and more specifically, to a projector-type vehicle lamp.

### BACKGROUND

A general projector-type vehicle lamp includes a projection lens, a light source disposed on the rear side of the vehicle of the rear focal point of the projection lens, a reflector that reflects light from the light source, and a shade that blocks a portion of the reflected light (see, for example, Patent Document 1). When the light source is turned on, the emitted light from the light source is reflected by the reflector, and the reflected light is incident on the projection lens and irradiated from the projection lens, forming a prescribed light distribution pattern.

### CITATION LIST

### Patent Literature

Patent Document 1: JP 2010-123473 A

### SUMMARY OF INVENTION

### Technical Problem

In addition, as a conventional vehicle lamp, the vehicle lamp shown in FIG. 10 is known.

The vehicle lamp 100 in FIG. 10 includes a light source 200, a reflector 300 that reflects light from the light source 200, a projection lens 400, and a shade 500 that blocks a portion of the reflected light from the reflector 300. The first focal point F1 and the second focal point F2 of the reflector 300 are located on the optical axis Z of the projection lens 400. The light source 200 is disposed so as to coincide with the first focal point F1 of the reflector 300. The second focal point F2 of the reflector 300 coincides with or is located in the vicinity of the rear focal point F3 of the projection lens 400. The reflective surface of the reflector 300 is formed as an ellipsoid of revolution with the optical axis Z of the projection lens 400 as the axis of rotation.

In the vehicle lamp 100, when the light source 200 is turned on, the emitted light L0 from the light source 200 is reflected by the reflector 300 and then condensed at the second focal point F2. Since the second focal point F2 of the reflector 300 coincides with or is located in the vicinity of the rear focal point F3 of the projection lens 400, the reflected light L1, L2, and L3 reflected by the reflector 300 passes through the rear focal point F3 of the projection lens 400 or its vicinity. In other words, the reflected light L1, L2, and L3 reflected by the reflector 300 passes through the second focal point F2 of the reflector 300 or its vicinity. At this time, a portion of the reflected light is blocked by the shade 500. After that, the reflected light L1, L2, and L3 is incident on the projection lens 400 and is irradiated as a prescribed light distribution pattern P100 above the HL-HR line (VU side) of the screen as shown in FIG. 11.

The area indicated by the dotted line in FIG. 11 indicates the area that the reflected light blocked by the shade 500 would have irradiated if the shade 500 had not been present.

The vehicle lamps disclosed in Patent Document 1 and shown in FIG. 10 are commonly and widely used vehicle lamps, but in such vehicle lamps, it is sometimes necessary to expand the light distribution pattern in order to widen the visible area.

As such, the vehicle lamp 110 shown in FIG. 12 is known as a vehicle lamp capable of expanding the light distribution pattern.

The vehicle lamp 110 in FIG. 12 expands the light distribution pattern (FIG. 11) of the vehicle lamp 100 in FIG. 10 in the upward direction. The vehicle lamp 110 has the same configuration as the vehicle lamp 100, except that the shape of the reflector 301 is different from that of the reflector 300 of the vehicle lamp 100. The reflector 301 in FIG. 12 is different in shape from the reflector 300 in FIG. 11 in that the reflective surface of the reflector 300 in FIG. 11 is formed as an ellipsoid of revolution, whereas the reflective surface of the reflector 301 in FIG. 12 is formed by a free-form surface based on an ellipsoid of revolution.

The reflector 301 has a reflective surface that is gradually changed so that the light reflected closer to the side of the light source 200 passes in the vicinity of the second focal point F2, and the light reflected farther on the side farther from the light source passes closer to the projection lens 400 side (front direction side of the vehicle) than the second focal point F2 on the optical axis Z of the projection lens 400.

As described above, the reflector 301 has a reflective surface formed by a free-form surface based on an ellipsoid of revolution. The area of the reflective surface of the reflector 301 that is located on the side close to the light source 200 is provided with a curvature such that the reflected light L1 passes the vicinity of the second focal point F2 so that the emitted light L11 from the projection lens 400 is irradiated near the HL-HR line of the screen (mainly the condensed light pattern) as shown in FIG. 13. On the other hand, the area of the reflective surface of the reflector 301 that is located on the side far from the light source 200 is provided with a curvature such that the reflected light L2 and L3 passes through points F20 and F21 that are separated from the second focal point F2 on the optical axis Z so that the reflected light L2 and L3 is irradiated on the side far from the HL-HR line of the screen (mainly the diffused pattern). That is, the reflective surface is adjusted so that the light reflected on the side farther from the light source 200 passes in front of the second focal point F2 (in the direction separated from the light source 200 on the optical axis, that is, the projection lens 400 side). The curvature of the reflective surface is determined taking into consideration that the reflected light is not blocked by the shade 500 and is incident on the projection lens 400.

In the above-described vehicle lamp 110, when the light source 200 is turned on, the emitted light L0 from the light source 200 is reflected by the reflector 301. The reflected light L1 reflected on the side of the reflector 301 close to the light source 200 passes through the second focal point F2 or its vicinity (i.e., the rear focal point F3 of the projection lens 400 or its vicinity, which is omitted in FIG. 12). The reflected light L2 reflected on the side of the reflector 301 farther from the light source 200 passes through a point F20 closer to the projection lens 400 side (front direction side of the vehicle) than the second focal point F2. The reflected light L3 reflected on the side of the reflector 301 even farther from the light source 200 passes through a point F21 on a side even closer to the projection lens 400 (more in the front direction side of the vehicle) than the second focal point F2. That is, the more the reflected light is reflected on the side of the reflector 301 farther from the light source 200, the closer the points F20 and F21 intersecting with the optical axis Z of the projection lens 400 are to the projection lens 400 side (front direction side of the vehicle). This allows the light distribution pattern P200 irradiated from the projection lens 400 to be extended upwardly. As shown by the arrows in FIG. 13, the top end of the obtained light distribution pattern P200 extends further upwardly than the light distribution pattern P100 in FIG. 11 shown by the dotted line.

According to the above-described vehicle lamp 110, the shape of the reflector 301 is adjusted so that the light reflected on the side farther from the light source 200 passes further toward the front than the second focal point F2 (in the direction separated from the light source 200 on the optical axis, i.e., toward the projection lens 400 side), thereby making it possible to expand the upper end of the light distribution pattern upwardly.

However, for this type of vehicle lamp, depending on the type of vehicle, there may be a demand for a thinner lens vertical dimension. Effective ways to make the lamp thinner include, for example, eliminating the shade or changing the location of the rear focal point of the projection lens, but as shown in Patent Document 1 and FIGS. 10 to 13 above, the conventional method of gradually shifting the second focal point of the reflective surface toward the lens side has the problem that it is not possible to expand the light distribution pattern.

The objective of the present disclosure is to provide a vehicle lamp that can effectively and appropriately expand appropriate parts of the light distribution pattern.

### Solution to Problem

The vehicle lamp according to the present disclosure is provided with a light source, a reflector having a reflective surface that reflects light from the light source, and a projection lens that forms a light distribution pattern by irradiating reflected light from the reflective surface to the front of the vehicle, wherein the reflective surface has a main reflection area and an expansion area in this order from the light source side toward the projection lens, the main reflection area has a first focal point located at the light source or its vicinity, and a second focal point located on the projection lens side of the first focal point, the projection lens has a rear focal point located on the light source side of the second focal point, and the expansion area is an area that reflects light from the light source toward the projection lens through a location on the light source side of the second focal point.

### Effects of the Invention

According to the present disclosure, it is possible to provide a vehicle lamp that can effectively and appropriately expand a light distribution pattern.

### BRIEF DESCRIPTION OF DRAWINGS

FIG. 1 is a perspective view of a vehicle lamp shown as an embodiment of the present disclosure.

FIG. 2 is an exploded perspective view of the vehicle lamp of FIG. 1.

FIG. 3 is a cross-sectional view taken along line A-A of FIG. 1.

FIG. 4 is a conceptual diagram of a vehicle lamp shown as an embodiment of the present disclosure.

FIG. 5 is an enlarged view of a portion indicated by the reference character N in FIG. 4.

FIG. 6 is a diagram showing a light distribution pattern irradiated by the vehicle lamp shown in FIG. 4.

FIG. 7 is a conceptual diagram of a vehicle lamp in which an expansion area Y is not present on the reflective surface of a reflector.

FIG. 8 is a diagram showing a light distribution pattern irradiated by a vehicle lamp in which the expansion area Y is not present on the reflective surface of the reflector.

FIG. 9 is a conceptual diagram viewed from the arrow a in FIG. 2.

FIG. 10 is a conceptual diagram showing an example of a configuration of a conventional projector-type vehicle lamp.

FIG. 11 is a diagram showing a light distribution pattern irradiated by the vehicle lamp shown in FIG. 10.

FIG. 12 is a conceptual diagram showing an example of a configuration in which a light distribution pattern is expanded in a conventional vehicle lamp.

FIG. 13 is a diagram showing an expanded light distribution pattern in the vehicle lamp shown in FIG. 12.

### DESCRIPTION OF EMBODIMENTS

An example of an embodiment of a vehicle lamp according to the present disclosure will be explained in detail below with reference to the drawings. Note that the present disclosure is not limited to this embodiment. In FIGS. 6, 8, 11, and 13, the reference characters “VU-VD” indicate the vertical lines at the top and bottom of the screen. The reference characters “HL-HR” indicate the horizontal lines at the left and right of the screen. In this specification, the terms “front,” “rear,” “up,” “down,” “left,” and “right” refer to the front, rear, up, down, left, and right when the vehicle lamp is installed in a vehicle.

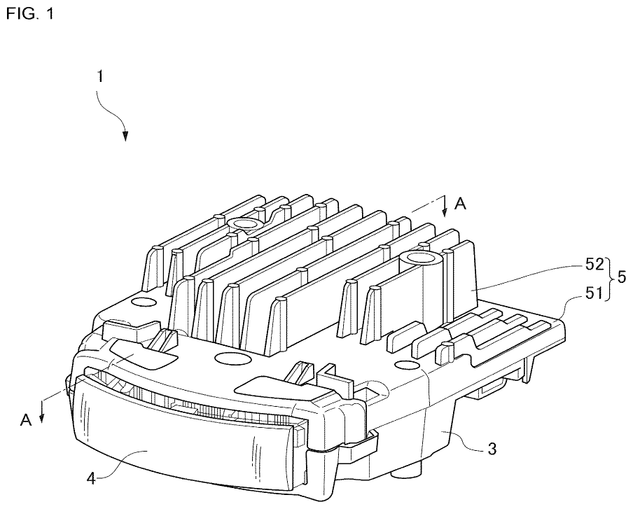

The configuration and operation of a vehicle lamp in this embodiment will be explained below with reference to FIGS. 1 to 9. Here, as an example, a headlamp for an automobile lamp will be described, in particular, a lamp for irradiating a high beam (beam for driving) light distribution pattern. A lamp for irradiating a low beam (beam for passing other vehicles) has a configuration in which the high beam light distribution pattern is irradiated upside down.

### Vehicle Lamp 1

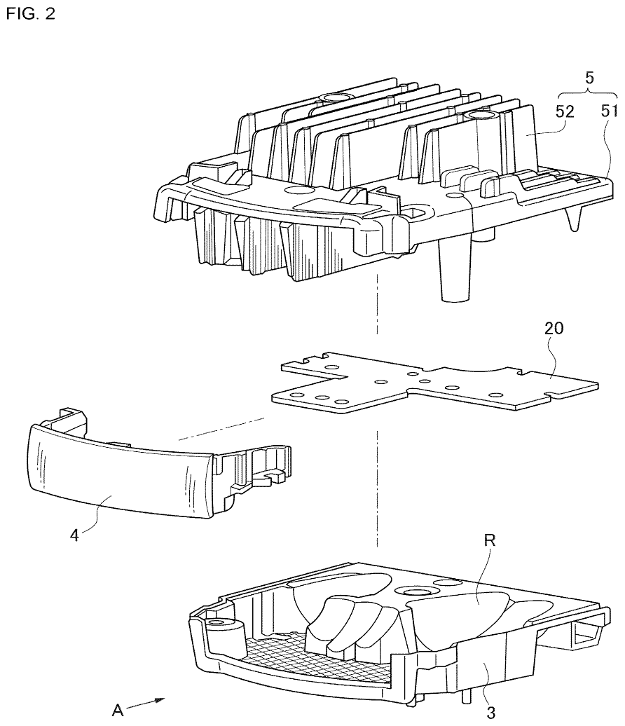

In FIGS. 1 to 4, reference number 1 denotes a vehicle lamp in this embodiment. The vehicle lamp 1 is mounted on each of the left and right sides of the front of the vehicle. The vehicle lamp 1 is provided with a light source 2, a reflector 3, and a projection lens 4. Also, in FIGS. 1 and 2, reference number 5 denotes a heat sink member 5 to which the light source 2, reflector 3, and projection lens 4 are attached. Note that FIGS. 1 and 2 show an example of a configuration in which multiple sets of the light source 2, reflector 3, and projection lens 4 are provided in the width direction of the vehicle.

The light source 2, the reflector 3, the projection lens 4, and the heat sink member 5 constitute a projector-type lamp unit that irradiates a prescribed light distribution pattern (in this example, the high beam light distribution pattern shown in FIG. 6) to the outside, i.e., in front of the vehicle. The light source 2, the reflector 3, the projection lens 4, and the heat sink member 5 are disposed in a lamp chamber, and are attached to a lamp housing via an up-down optical axis adjustment mechanism (not shown) and a left-right optical axis adjustment mechanism (not shown).

In addition, lamp units other than the light source 2, the reflector 3, the projection lens 4, and the heat sink member 5 may be disposed in the lamp chamber, such as, for example, a low beam light distribution pattern irradiation lamp unit, a clearance lamp unit, a turn signal lamp unit, and a daytime running lamp unit. In addition, an inner panel (not shown), an inner housing (not shown), and an inner lens (not shown) may be disposed in the lamp chamber.

### Heat Sink Member 5

The heat sink member 5 is a member used as necessary, and is made of a material with high thermal conductivity, such as, for example, a metal die casting (aluminum die casting). The light source 2, the reflector 3, and the projection lens 4 are attached to the heat sink member 5. The heat sink member 5 serves both as a heat dissipation member and an attachment member.

The heat sink member 5 includes a plate section 51 as an attachment section, and multiple fin parts 52 as heat dissipation parts. The multiple fin parts 52 are integrally provided perpendicularly to the upper surface of the plate section 51 and parallel or nearly parallel in the front-rear direction.

### Light Source 2

The light source 2 is a semiconductor-type light source, for example, a self-luminous semiconductor-type light source such as an LED, an OEL, or an OLED (organic electroluminescence). In this embodiment, the light source 2 is attached to the heat sink member 5 via a plate-shaped substrate 20. The upper surface of the substrate 20 is attached to the lower surface of the plate section 51 of the heat sink member 5, and the light source 2 is mounted on the lower surface of the substrate 20 at a location facing the reflective surface R of the reflector 3. A current is supplied to the light source 2 from a lighting circuit (not shown).

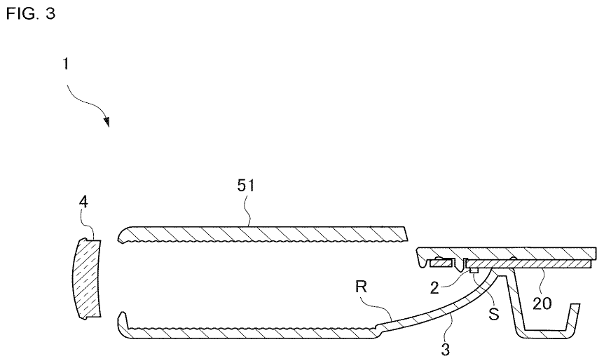

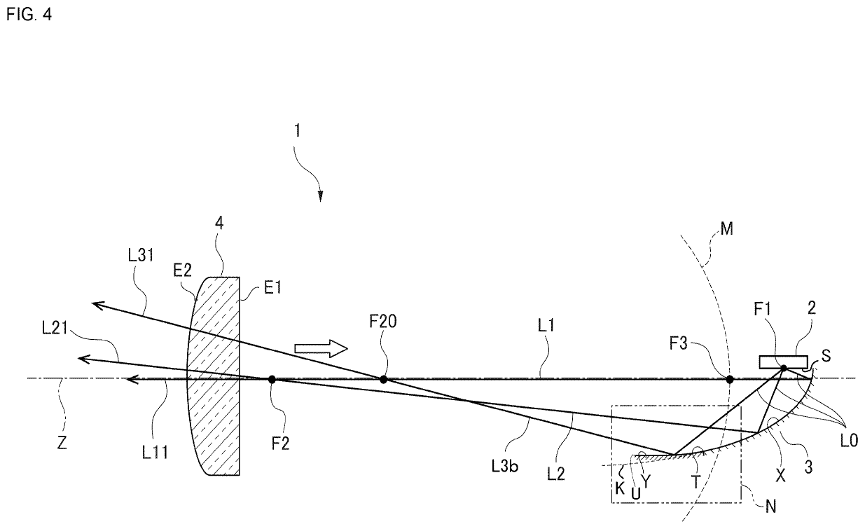

The light source 2 has a light-emitting surface S that emits light. In this example, the light-emitting surface S faces downward and has a square shape as shown in FIGS. 3 and 4. The light-emitting surface may be rectangular. The center point of the light-emitting surface S coincides with or nearly coincides with a first focal point F1 of a main reflection area X of the reflective surface R of the reflector 3. When the light-emitting surface S is rectangular, the longitudinal direction of the light-emitting surface S is orthogonal or nearly orthogonal to the optical axis Z of the projection lens 4 in the left-right direction. In the example of FIG. 4, the light-emitting surface S is above the optical axis Z of the projection lens 4.

### Reflector 3

The reflector 3, for example, is made of a material that is highly heat-resistant and light-impermeable, such as a resin member. In this embodiment, the reflector 3 is attached to the heat sink member 5. The reflector 3 has a hollow shape with its front and upper portions open and its rear, lower and both left and right portions closed. The reflector 3 has a reflective surface R that reflects light from the light source 2. The reflective surface R is a converging reflective surface that extends from the vicinity of the light source 2 toward the projection lens 4 side. The reflective surface R faces the light-emitting surface S of the light source 2.

As shown in FIG. 4, the reflective surface R has a main reflection area X and an expansion area Y in this order from the light source 2 side toward the projection lens 4. The main reflection area X is formed as an ellipsoid of revolution or a surface based on an ellipsoid of revolution with the optical axis Z of the projection lens 4 as the axis of rotation, and the expansion area Y is formed by a free-form surface. The main reflection area X is a reflective surface formed so that the radius of curvature gradually increases from the light source 2 side toward the projection lens 4, and the expansion area Y is a reflective surface whose radius of curvature is smaller than that of the tip end T of the main reflection area X on the projection lens 4 side. With this configuration, the radius of curvature of the main reflection area X gradually increases (the curvature decreases, i.e., the curve becomes gentler) from the light source 2 side toward the projection lens 4, and when it reaches the expansion area Y located further in front on the projection lens 4 side, it becomes a curved surface with a radius of curvature smaller (the curvature increases, i.e., the curve becomes steeper) than the radius of curvature of the main reflection area X. The main reflection area X and the expansion area Y are formed into a smoothly continuous surface. That is, the surface of the reflective surface R, including the expansion area Y, is formed as a continuous surface without any steps from the projection lens 4 side toward the light source 2.

### Projection Lens 4

The projection lens 4 is a lens made of resin, for example, such as a PC material or PMMA material. In this embodiment, the projection lens 4 is attached to the heat sink member 5 directly or via a separate holder (not shown).

The projection lens 4 is an aspheric projection lens. It is composed of an incident surface E1 on the rear surface and an emission surface E2 on the front surface.

The incident surface E1 faces the reflector 3. The incident surface E1 is flat or forms a convex or concave surface with respect to the reflector 3. The emission surface E2 forms an aspheric convex surface.

### Explanation of the Optical System for the Light Source, Reflector, and Projection Lens

In the following explanation, a light source is specified at one location, and the explanation will be given based on the light emitted from the light source with reference to FIG. 4.

In this vehicle lamp 1, the light source 2 irradiates the emitted light L0 downward. The rear focal point of the projection lens 4 (the focal point constituting the lens image surface M) is located at the position indicated by the reference character F3 in the vicinity of the light source 2. As described above, the light source 2 coincides with or nearly coincides with the first focal point F1 of the main reflection area X of the reflective surface R of the reflector 3, so that the rear focal point F3 of the projection lens 4 is located on the light source 2 side (rear side) with respect to the tip U of the expansion area Y (the end of the reflector 3 on the projection lens 4 side). In addition, a portion of the lens image surface M of the projection lens 4 intersects with a portion of the reflector 3. That is, a portion of the lens image surface M of the projection lens 4 crosses a portion of the reflector 3. In addition, in FIG. 4, the expansion area Y is provided in front of the lens image surface M (on the projection lens 4 side).

When the light source 2 is turned on, the emitted light L0 emitted downward from the light source 2 is reflected by the reflective surface R of the reflector 3. The main reflection area X on the reflective surface R of the reflector 3 has a first focal point F1 located at or in the vicinity of the light source 2, and a second focal point F2 located on the projection lens 4 side with respect to the first focal point F1. That is, the first focal point of the main reflection area X is located at a position indicated by the reference character F1 at or in the vicinity of the light source 2. The first focal point of the main reflection area X is located slightly above the optical axis Z of the projection lens 4.

The second focal point of the main reflection area X is located at a position indicated by the reference character F2 in the vicinity of the projection lens 4 on the optical axis Z of the projection lens 4. The second focal point F2 and the rear focal point F3 of the projection lens 4 do not coincide in location, and the second focal point F2 is located on the front side (projection lens 4 side) of the rear focal point F3 of the projection lens 4. That is, the second focal point F2 is located between the projection lens 4 and the rear focal point F3.

As described above, the expansion area Y has a smaller radius of curvature (larger curvature) than the tip end T of the main reflection area X, so when it receives the emitted light L0 from the light source 2, the reflected light thereof L3b intersects at a point F20 on the optical axis Z that is on the light source 2 side with respect to the second focal point F2 of the main reflection area X, and travels toward the projection lens 4. That is, the expansion area Y reflects the emitted light L0 from the light source 2 toward the projection lens 4 through the point F20 that is on the light source 2 side with respect to the second focal point F2 of the main reflection area X.

In addition, in this embodiment, the expansion area Y is formed such that the point where the light from the light source 2 intersects with the optical axis Z gradually shifts rearward (light source 2 direction) from the second focal point F2 of the main reflection area X. That is, the expansion area Y is configured such that the point F20 where the light reflected in the expansion area Y intersects with the optical axis Z of the projection lens 4 gradually shifts from the projection lens 4 side toward the light source 2 side as the point where the light from the light source 2 is reflected shifts (moves) from the light source 2 side toward the projection lens 4 side. In addition, the distance between the first focal point F1 of the main reflection area X and the point F20 where the reflected light L3b by the expansion area Y intersects with the optical axis Z (the focal point distance in the expansion area Y) is shorter than the focal point distance between the first focal point F1 and the second focal point F2 of the main reflection area X (the focal point distance in the main reflection area X). In addition, the distance between the first focal point F1 and the point F20 where the reflected light L3b by the expansion area Y intersects with the optical axis Z (the focal point distance in the expansion area Y) becomes shorter as the point in the expansion area Y where the light from the light source 2 is reflected is farther away from the light source 2.

### Effects of the Vehicle Lamp 1

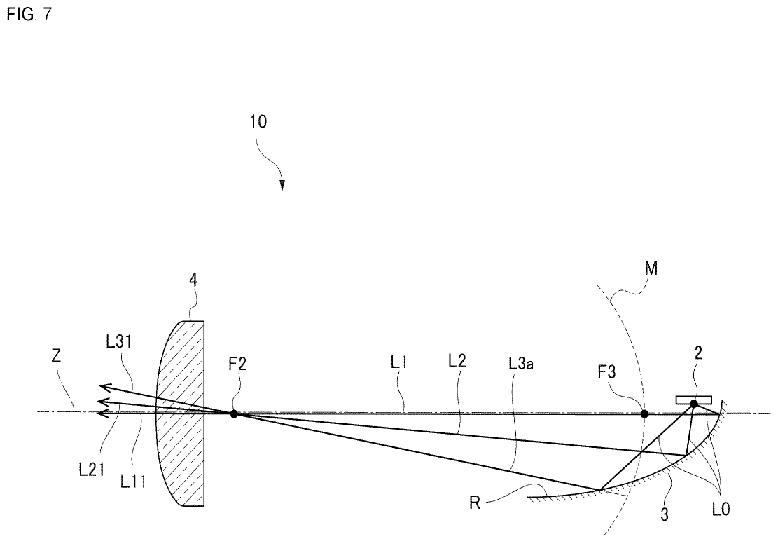

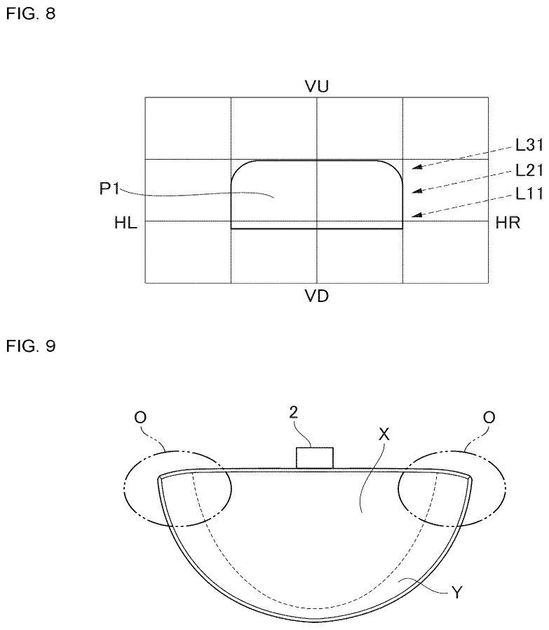

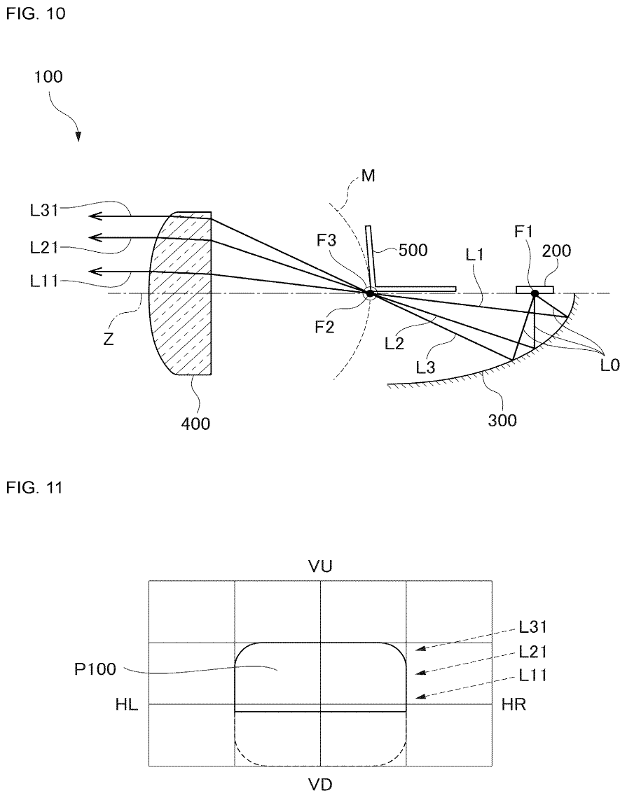

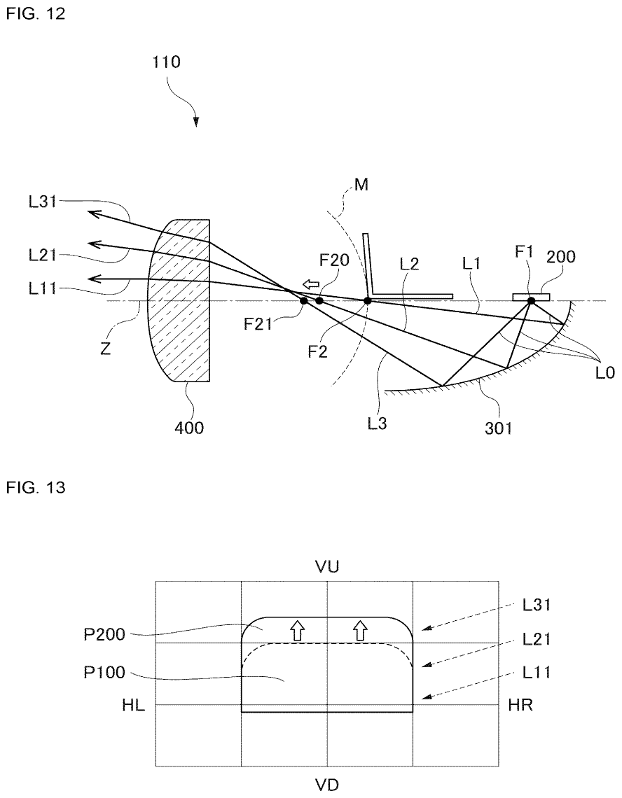

First, in order to deepen understanding of the content of the present disclosure, a case where the expansion area Y is not present on the reflective surface of the reflector will be explained. FIGS. 7 and 8 are diagrams for explaining this.

The vehicle lamp 10 shown in FIG. 7 has the same configuration as the vehicle lamp 1 in FIG. 4, except that the reflective surface R of the reflector 3 is configured by extending the main reflection area (i.e., only the main reflection area) instead of the expansion area Y. This reflective surface R is formed as an ellipsoid of revolution or a surface based on an ellipsoid of revolution. The vehicle lamp 10 irradiates the light distribution pattern P1 shown in FIG. 8.

In the vehicle lamp 10, the reflected light L1 reflected in an area of the reflective surface R of the reflector 3 near the light source 2 is incident on an area near the optical axis Z of the projection lens 4 and is irradiated as the emitted light L11 to the vicinity of the HL-HR line of the screen, forming the vicinity of the center of the light distribution pattern P1. The reflected light L2 reflected in an area of the reflective surface R slightly separated from the light source 2 is incident on an area above the optical axis Z of the projection lens 4 and is irradiated as the emitted light L21 to an area separated from the HL-HR line, forming the upper side (the reference character VU side) of the light distribution pattern P1 from the vicinity of the center. The reflected light L3a reflected in an area of the reflective surface R further separated from the light source 2 is incident on an area further above the optical axis Z of the projection lens 4 and is irradiated as the emitted light L31 to the area further separated from the HL-HR line, forming the vicinity of the upper end of the light distribution pattern P1 shown in FIG. 8.

Next, referring to FIGS. 4 to 6, the effects of the case where the configuration shown in FIG. 7 is modified to form an expansion area Y on the reflective surface of the reflector will be explained. The expansion area Y has the effect of expanding an appropriate point (the upper end in this example) of the light distribution pattern by reflecting the light from the light source 2 toward the projection lens 4 through a location on the light source 2 side of the second focal point F2 of the main reflection area X. The vehicle lamp 1 irradiates the light distribution pattern P2 shown in FIG. 6.

As shown in FIGS. 4 to 6, of the emitted light L0 emitted from the light source 2, the reflected light L1 reflected in the vicinity of the light source 2 in the main reflection area X of the reflective surface R of the reflector 3 passes through the first focal point of the main reflection area X through the vicinity of the optical axis Z, is incident on the area near the optical axis Z of the projection lens 4 (vicinity of the center of the projection lens 4), and is irradiated as the emitted light L11 in the vicinity of the HL-HR line of the screen, forming the vicinity of the center of the light distribution pattern P2 shown in FIG. 6. The reflected light L2 reflected in the main reflection area X slightly separated from the light source 2, for example, passes through the second focal point F2, is incident on the area slightly above the optical axis Z of the projection lens 4, and is irradiated as emitted light L21 to an area separated from the HL-HR line, forming a slightly upper side (the reference character VU side) than the vicinity of the center of the light distribution pattern P2. Further, the reflected light L3b reflected in the expansion area Y, which is separated from the light source 2, passes through the optical axis Z of the projection lens 4 at a point F20 on the light source 2 side of the second focal point F2 of the main reflection area X, is incident on an area further above the optical axis Z of the projection lens 4, and is irradiated as the emitted light L31 further above the HL-HR line (the reference character VU side), forming the vicinity of the upper end of the light distribution pattern P2. At this time, the reflected light L3b shown in FIG. 4 has a larger angle of intersection with the optical axis Z than the reflected light L3a shown in FIG. 7 when the expansion area Y is not present. In addition, the reflected light L3b is incident on the projection lens 4 at a location further upward than the reflected light L3a when the expansion area Y is not present. This makes it possible to irradiate a light distribution pattern P2 in which the upper end (indicated by the dotted line in FIG. 6) of the light distribution pattern P1 irradiated by the vehicle lamp 10 in FIG. 7 is extended (i.e., expanded) in the upward direction (the arrow direction in FIG. 6; the VU direction of the screen). That is, the vehicle lamp 1 can move the upper end of the light distribution pattern P1 of the vehicle lamp 10 farther away from the HL-HR line.

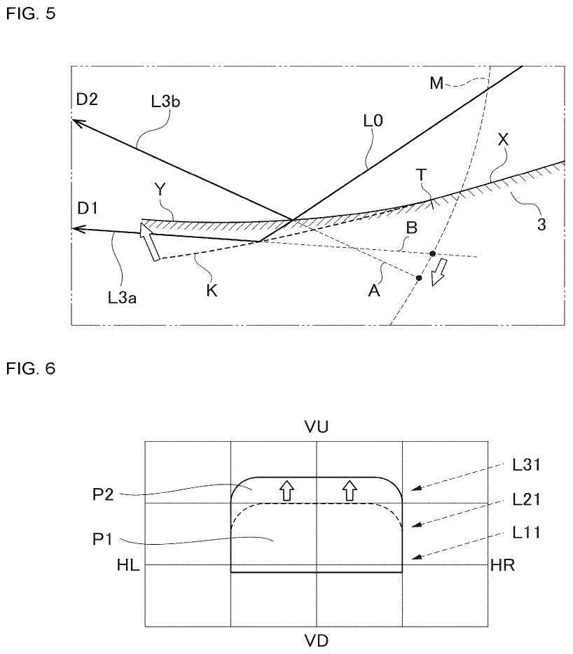

In addition, the vehicle lamp 1 will be explained in more detail with reference to FIG. 5, which is an enlarged view of the portion indicated by the reference character N in FIG. 4. In FIG. 5, the dotted line indicated by the reference character K indicates an extension area K obtained by further extending the main reflection area X from the tip end T toward the projection lens 4 side. The reflective surface having the extension area K has the same shape as the reflective surface of the reflector in the case where the expansion area Y is not present as shown in FIG. 7. The extension area K is formed so that the radius of curvature gradually increases from the tip end T toward the projection lens 4, following the main reflection area X. As shown in FIG. 5, the emitted light L0 toward the extension area K is reflected at a small angle (reflected light L3a) and moves in the direction indicated by the reference character D1. On the other hand, the expansion area Y has a smaller radius of curvature (larger curvature) than the extension area K, as shown by the white arrow in FIG. 5, and is curved upward from the extension area K. The emitted light L0 toward the expansion area Y is reflected upward at an angle larger than the reflected light L3a reflected by the extension area K (reflected light L3b), and travels in the direction indicated by the reference character D2, which is higher than the direction D1. As a result, in a configuration having the expansion area Y, it is possible to irradiate a light distribution pattern P2 in which the upper end of the light distribution pattern irradiated from the projection lens 4 is extended upward.

In addition, in FIG. 5, the dotted line indicated by the reference character A is a line (reverse optical path) extending the optical path of the reflected light L3b reflected in the expansion area Y toward the lens image surface M side of the projection lens 4, and the dotted line indicated by the reference character B is a line (reverse optical path) extending the optical path of the reflected light L3a reflected in the extension area K toward the lens image surface M side. As shown in FIG. 5, the intersection point of the reverse optical path A of the reflected light L3b reflected in the expansion area Y and the lens image surface M is farther separated from the light source than the intersection point of the reverse optical path B of the reflected light L3a reflected in the extension area K and the lens image surface M. This makes it possible to irradiate a light distribution pattern P2 in which the upper end of the light distribution pattern P1 irradiated from the projection lens 4 is extended upward.

According to the above-mentioned vehicle lamp 1, the reflective surface R of the reflector 3 has an expansion area Y that is formed at or in the vicinity of the end on the projection lens 4 side and that reflects the light from the light source 2 toward the projection lens 4 through a location on the light source 2 side of the second focal point of the reflective surface R, so that the upper end of the light distribution pattern can be expanded upward. It is also possible to expand the light distribution pattern downward by reversing the up and down of the light source and the reflector. In this way, by reflecting the light from the light source 2 toward the projection lens 4 through a location on the light source 2 side of the second focal point F2, it is possible to effectively and appropriately expand appropriate parts of the light distribution pattern.

Furthermore, in the above-mentioned vehicle lamp 1, the expansion area Y is formed so that the point where the light from the light source 2 intersects with the optical axis Z gradually shifts rearward (toward the light source 2) from the second focal point F2 of the main reflection area X, so that the farther the point where the light from the light source 2 is reflected in the expansion area Y toward the projection lens 4 side, the more the light is reflected toward the upper side of the projection lens 4, and the more the upper end of the light distribution pattern can be expanded upward. The extent the upper end is expanded upward can be appropriately adjusted by changing the length and curvature of the expansion area Y depending on the location and direction of the object for which increased visibility is required.

In addition, in the above-mentioned vehicle lamp 1, the rear focal point F3 of the projection lens 4 is located close to the reflective surface R of the reflector 3, so the pattern projected on the reflector 3 is similar to the irradiated light distribution pattern. This eliminates the need for a shade that blocks a portion of the reflected light from the reflective surface R of the reflector 3 to adjust the shape of the light distribution pattern, making it possible to reduce the size of the vehicle lamp. In addition, since the distance between the light source 2 and the reflector 3 is short, the illuminance value of the light that hits the reflector 3 can be increased, thereby increasing the luminous intensity of the irradiated light.

In addition, since the main reflection area X and the expansion area Y on the reflective surface R of the reflector 3 are formed as a continuous surface without any steps, streaks are less likely to occur in the light distribution pattern.

In the above embodiment, the second focal point of the main reflection area X forming the reflective surface R of the reflector 3 is provided in the vicinity of the projection lens 4, but the location is not limited and can be changed as appropriate on the front side of the rear focal point F3 of the projection lens 4 (projection lens 4 side). The first focal point of the main reflection area X is located slightly above the optical axis Z of the projection lens 4, but it may also be located on the optical axis Z of the projection lens 4.

In addition, the expansion area Y is formed by a free-form surface, but it may also be a free-form surface based on an ellipsoid of revolution (with the optical axis Z of the projection lens 4 as the axis of rotation) with a smaller radius of curvature than the main reflection area X.

In addition, the light source 2 is attached to the heat sink member 5 via a plate-shaped substrate 20, but may be attached to another attachment member instead of the heat sink member 5.

In addition, the rear focal point F3 of the projection lens 4 is located in the vicinity of the light source 2, but may be on the front side of the light source 2 (projection lens 4 side) or in the rear of it.

In addition, the vehicle lamp 1 may have a shade that blocks a portion of the reflected light from the reflective surface R of the reflector 3, but it is preferable not to have a shade for forming a light distribution pattern in particular in terms of enabling miniaturization.

In addition, a portion of the lens image surface M of the projection lens 4 intersects with a portion of the reflector 3, but may be located on the rear side of the reflector.

In the above embodiment, an example of expanding the light distribution pattern in the vertical direction has been explained, but by forming the expansion area Y to a location close to the horizontal cross section of the optical axis Z, it is also possible to expand the light distribution pattern in the left-right direction. Explaining in detail based on FIG. 9, by forming the expansion area Y to a height close to the light source 2, the curvature of the expansion area Y in the areas O close to the light source 2 becomes larger than the curvature of the main reflection area X. The light reflected in the expansion area Y in the areas O passes through a location closer to the light source 2 side than the second focal point F2 and is reflected toward the projection lens 4, and can irradiate the HL side and the HR side of the VU-VD line of the screen in FIG. 6. This makes it possible to expand the light distribution pattern in the left-right direction.

In the above embodiment, one configuration example in which multiple sets of the light source 2, the reflector 3, and the projection lens 4 are provided in the width direction of the vehicle has been shown, but it is sufficient to have one or more sets of the light source 2, the reflector 3, and the projection lens 4, and the number can be appropriately selected according to the vehicle model and the like. Also, one or more sets of the light source 2, the reflector 3, and the projection lens 4 can be used in combination with different optical systems.

The configuration of the present disclosure is as follows.
[1] A vehicle lamp provided with: a light source; a reflector having a reflective surface that reflects light from the light source; and a projection lens that forms a light distribution pattern by irradiating the reflected light from the reflective surface in front of the vehicle,
wherein the reflective surface has a main reflection area and an expansion area in this order from the light source side toward the projection lens,
the main reflection area has a first focal point located at or in the vicinity of the light source, and a second focal point located on the projection lens side of the first focal point,
the projection lens has a rear focal point located on the light source side of the second focal point,
and the expansion area is an area that reflects light from the light source toward the projection lens through a location on the light source side of the second focal point.
[2] The vehicle lamp according [1], wherein the main reflection area is formed as an ellipsoid of revolution or a surface based on an ellipsoid of revolution, and the radius of curvature of the expansion area is smaller than the radius of curvature of the end of the main reflection area on the projection lens side.
[3] The vehicle lamp according to [1] or [2], wherein the expansion area is configured such that, as a point at which light from the light source is reflected shifts from the light source side toward the projection lens side, a point at which the light reflected in the expansion area intersects with an optical axis of the projection lens gradually shifts from the projection lens side toward the light source side.
[4] The vehicle lamp according to any one of [1] to [3], wherein the reflective surface is formed as a continuous surface without steps from the projection lens toward the light source, the surface including the expansion area.
[5] The vehicle lamp according to any one of [1] to [4], wherein a rear focal point of the projection lens is located on the light source side of a tip end of the expansion area.
[6] The vehicle lamp according to any one of [1] to [5], wherein a portion of an image surface of the projection lens intersects with the reflector.

### REFERENCE SIGNS LIST

1, 10, 100, 110 Vehicle lamp
2, 200 Light source
3, 300, 301 Reflector
4, 400 Projection lens
5 Heat sink member
20 Substrate
51 Plate section
52 Fin parts
500 Shade
E1 Incident surface
E2 Emission surface
F1 First focal point
F2 Second focal point
F3 Rear focal point of projection lens
K Extension area
L0 Emitted light from light source
L1, L2, L3, L3a, L3b Reflected light
L11, L21, 31 Emission light
M Lens image surface
P1, P2, P100, P200 Light distribution pattern
R Reflective surface
S Light-emitting surface
T Tip end
X Main reflection area
Y Expansion area
Z Optical axis

1. A vehicle lamp comprising: a light source; a reflector having a reflective surface that reflects light from the light source; and a projection lens that forms a light distribution pattern by irradiating the reflected light from the reflective surface in front of the vehicle,
wherein the reflective surface has a main reflection area and an expansion area in this order from the light source side toward the projection lens,
the main reflection area has a first focal point located at or in the vicinity of the light source, and a second focal point located on the projection lens side of the first focal point,
the projection lens has a rear focal point located on the light source side of the second focal point,
and the expansion area is an area that reflects light from the light source toward the projection lens through a location on the light source side of the second focal point.

2. The vehicle lamp according to claim 1, wherein the main reflection area is formed as an ellipsoid of revolution or a surface based on an ellipsoid of revolution, and the radius of curvature of the expansion area is smaller than the radius of curvature of the end of the main reflection area on the projection lens side.

3. The vehicle lamp according to claim 1, wherein the expansion area is configured such that, as a point at which light from the light source is reflected shifts from the light source side toward the projection lens side, a point at which the light reflected in the expansion area intersects with an optical axis of the projection lens gradually shifts from the projection lens side toward the light source side.

4. The vehicle lamp according to claim 1, wherein the reflective surface is configured as a continuous surface without steps from the projection lens toward the light source, the surface including the expansion area.

5. The vehicle lamp according to claim 1, wherein a rear focal point of the projection lens is located on the light source side of a tip end of the expansion area.

6. The vehicle lamp according to claim 1, wherein a portion of an image surface of the projection lens intersects with the reflector.
